(19) United States
(12) Patent Application Publication
(10) Pub. No.: US 2025/0109836 A1
(43) Pub. Date: Apr. 3, 2025

(54) LIGHT-EMITTING DEVICE

(71) Applicant: NICHIA CORPORATION, Anan-shi (JP)

(72) Inventors: Takeshi KUSUSE, Tokushima-shi (JP); Shoichi YAMADA, Anan-shi (JP)

(21) Appl. No.: 18/892,106

(22) Filed: Sep. 20, 2024

(30) Foreign Application Priority Data
Sep. 28, 2023 (JP) 2023-167865

(51) Int. Cl. F21V 3/08; F21V 5/00; F21V 9/32; F21V 19/00; F21Y 115/10

(52) U.S. Cl. CPC F21V 3/08; F21V 5/002; F21V 9/32; F21V 19/0015; F21Y 2115/10

(57) ABSTRACT

A light-emitting device includes a light-emitting element and a plate-shaped light-transmissive member. The plate-shaped light-transmissive member is disposed on or above the light-emitting element. The light-transmissive member has a lower surface configured to receive light emitted from the light-emitting element and an upper surface opposite to the lower surface. The upper surface of the light-transmissive member serves as an emission surface. The light-transmissive member includes a first light-transmissive portion including a first sintered body containing a phosphor particle, and a second light-transmissive portion including a second sintered body containing a light-diffusing particle. The second sintered body has a relative density of 70% or more and 95% or less. The emission surface includes a first light-emitting region configured to emit light through the first light-transmissive portion, and a second light-emitting region configured to emit light through the second light-transmissive portion at a lower luminance than in the first light-emitting region.

### CROSS-REFERENCE TO RELATED APPLICATION

This application claims priority to Japanese Patent Application No. 2023-167865, filed on Sep. 28, 2023, the disclosure of which is hereby incorporated herein by reference in its entirety.

### TECHNICAL FIELD

The present disclosure relates to a light-emitting device.

### BACKGROUND

LEDs are used for light sources of vehicle lamps such as headlights in recent years. For example, Japanese Unexamined Patent Application Publication No. 2009-266434 discloses a light-emitting device that provides light distribution suitable for headlights by using a combination of a plurality of light-emitting elements having different light emitting areas.

### SUMMARY

An object of the present disclosure is to provide a light-emitting device having a high-luminance region and a low-luminance region in an emission surface.

A light-emitting device according to an embodiment in the present disclosure includes a light-emitting element and a plate-shaped light-transmissive member. The plate-shaped light-transmissive member is disposed on or above the light-emitting element. The light-transmissive member has a lower surface configured to receive light emitted from the light-emitting element and an upper surface opposite to the lower surface. The upper surface of the light-transmissive member serves as an emission surface. The light-transmissive member includes a first light-transmissive portion including a first sintered body containing a phosphor particle, and a second light-transmissive portion including a second sintered body containing a light-diffusing particle. The second sintered body has a relative density of 70% or more and 95% or less. The emission surface includes a first light-emitting region configured to emit light through the first light-transmissive portion, and a second light-emitting region configured to emit light through the second light-transmissive portion at a lower luminance than in the first light-emitting region.

A method of manufacturing a light-emitting device according to an embodiment in the present disclosure includes: providing a light-emitting element having an upper surface serving as a light exit surface; providing a light-transmissive member including a first light-transmissive portion having a first light incident surface and a first light exit surface and a second light-transmissive portion having a second light incident surface and a second light exit surface, and having a transmittance of light lower than in the first light-transmissive portion; and disposing the light-transmissive member on or above the light-emitting element so that the first light incident surface and the second light incident surface face the light exit surface of the light-emitting element.

With an embodiment of the present disclosure, a light-emitting device having a high-luminance region and a low-luminance region in an emission surface can be provided.

### BRIEF DESCRIPTION OF THE DRAWINGS

FIG. 1 is a schematic perspective view of a light-emitting device according to a first embodiment.

FIG. 2 is a schematic plan view of the light-emitting device according to the first embodiment.

FIG. 3 is a schematic cross-sectional view taken along the line III-III of FIG. 2.

FIG. 4 is a schematic plan view showing an example of a step in a method of manufacturing a light-emitting device according to the first embodiment.

FIG. 5 is a schematic cross-sectional view taken along the line V-V of FIG. 4.

FIG. 6 is a schematic plan view showing an example of a step in the method of manufacturing a light-emitting device according to the first embodiment.

FIG. 7 is a schematic cross-sectional view taken along the line VII-VII of FIG. 6.

FIG. 8 is a schematic cross-sectional view showing an example of a pressurizer used in the method of manufacturing a light-emitting device according to the first embodiment.

FIG. 9 is a schematic cross-sectional view of a member subjected to pressure sintering with the pressurizer in FIG. 8.

FIG. 10 is a schematic plan view showing an example of a step in the method of manufacturing a light-emitting device according to the first embodiment.

FIG. 11 is a schematic cross-sectional view taken along the line XI-XI of FIG. 10.

FIG. 12 is a schematic cross-sectional view of a light-transmissive member 10 manufactured by the method of manufacturing a light-emitting device according to the first embodiment.

FIG. 13 is a schematic cross-sectional view showing an example of a step in the method of manufacturing a light-emitting device according to the first embodiment.

FIG. 14 is a schematic cross-sectional view showing an example of a step in the method of manufacturing a light-emitting device according to the first embodiment.

FIG. 15 is a schematic cross-sectional view showing an example of a step in the method of manufacturing a light-emitting device according to the first embodiment.

FIG. 16 is a schematic cross-sectional view showing an example of a step in the method of manufacturing a light-emitting device according to the first embodiment.

FIG. 17 is a schematic cross-sectional view of a light-transmissive member 10-1 of a light-emitting device according to Modified Example 1 of the first embodiment.

FIG. 18 is a schematic cross-sectional view of a light-transmissive member 10-3 of a light-emitting device according to Modified Example 2 of the first embodiment.

FIG. 19 is a schematic cross-sectional view of a light-transmissive member 10-4 of a light-emitting device according to Modified Example 3 of the first embodiment.

FIG. 20 is a schematic plan view of a light-transmissive member 10-5 of a light-emitting device according to Modified Example 4 of the first embodiment.

FIG. 21 is a schematic plan view of a light-transmissive member 10-6 of a light-emitting device according to Modified Example 5 of the first embodiment.

FIG. 22 is a schematic plan view of a light-transmissive member 10-7 of a light-emitting device according to Modified Example 6 of the first embodiment.

FIG. 23 is a schematic plan view of a light-transmissive member 10-10 of a light-emitting device according to Modified Example 7 of the first embodiment.

FIG. 24 is a schematic perspective view of a light-emitting device according to a second embodiment.

FIG. 25 is a schematic plan view of the light-emitting device according to the second embodiment.

FIG. 26 is a schematic cross-sectional view taken along the line XXVI-XXVI of FIG. 25.

FIG. 27 is a schematic plan view of a light-emitting element 2 of the light-emitting device according to the second embodiment.

FIG. 28 is a schematic plan view of a wiring board 50 of the light-emitting device according to the second embodiment.

### DETAILED DESCRIPTIONS

Certain embodiments in the present disclosure are described below with reference to the accompanying drawings. The forms described below are intended to exemplify light-emitting devices and methods of manufacturing the light-emitting devices to give a concrete form to the technical idea of the present embodiments, and the present embodiments are not limited to the description below. Unless specifically stated otherwise, descriptions of the sizes, materials, shapes, and relative positions of constituent components described in the embodiments are not intended to limit the scope of the present invention to those descriptions, but are rather only examples. Sizes or positional relationships of components illustrated in the drawings may be exaggerated or simplified in order to clarify the descriptions. The illustration of components may be partly omitted, and an end view showing only a cross section of a member may be used as a cross-sectional view in order to prevent the drawings from being too complicated. The terms “covering” and “cover” include not only being in direct contact, but rather also include indirect covering, such as covering via another member disposed therebetween. The term “dispose” includes not only disposition in direct contact but also includes indirect disposition, such as disposition via another member therebetween. The term “plan view” as used in the present specification refers to a drawing taken from the emission surface side of the light-emitting device.

A light-emitting device of an embodiment according to the present disclosure includes a light-emitting element and a plate-shaped light-transmissive member being disposed on or above the light-emitting element and having a lower surface configured to receive light emitted from the light-emitting element and an upper surface opposite to the lower surface. The upper surface of the light-transmissive member serves as an emission surface. The light-transmissive member includes a first light-transmissive portion including a first sintered body containing a phosphor particle and a second light-transmissive portion including a second sintered body containing a light-diffusing particle. The second sintered body has a relative density of 70% or more and 95% or less. The emission surface includes (i) a first light-emitting region configured to emit light through the first light-transmissive portion and (ii) a second light-emitting region configured to emit light through the second light-transmissive portion at a lower luminance than in the first light-emitting region.

The relative density of the sintered body here is the ratio of the actual density to the theoretical density of the sintered body and is used as an index of the ratio of voids contained in the sintered body in the present specification.

In the present specification, unless specifically stated otherwise, an upper surface refers to an emission surface (that is, a surface on the side on which main light is emitted) of the light-emitting device, and a lower surface refers to a surface opposite to the upper surface.

Certain embodiments will be described below referring to examples of specific structures of the light-emitting device according to the present disclosure.

### First Embodiment

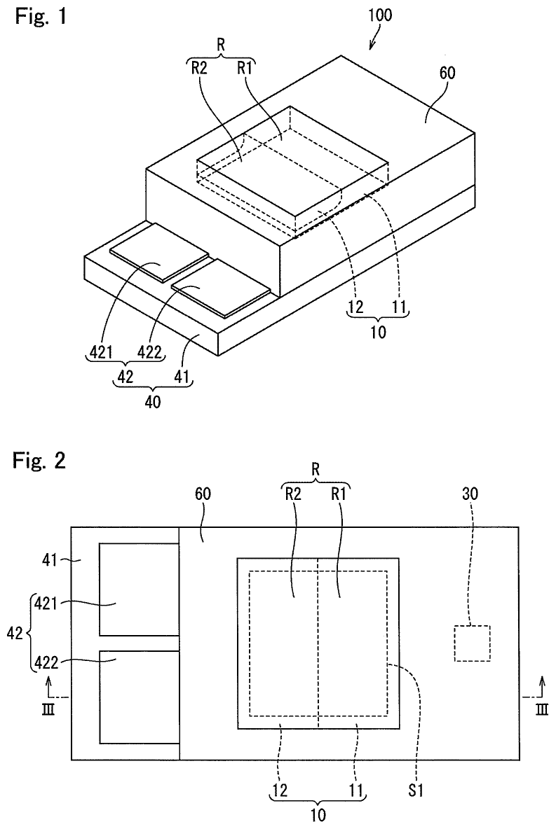

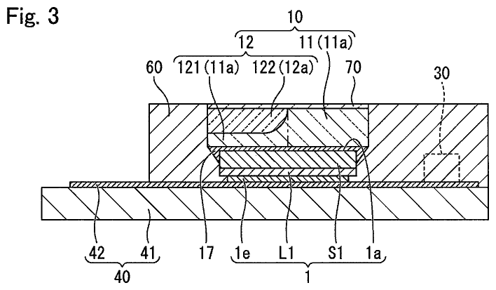

FIG. 1 is a schematic perspective view of a light-emitting device according to a first embodiment. FIG. 2 is a schematic plan view taken from above the light-emitting device according to the first embodiment. FIG. 3 is a schematic cross-sectional view taken along the line III-III of FIG. 2.

As shown in FIG. 1 to FIG. 3, a light-emitting device 100 according to the first embodiment includes a wiring board 40, a light-emitting element 1 disposed on the wiring board 40, and a light-transmissive member 10 disposed on the light-emitting element 1. The light-emitting device 100 may further include a covering member 60, an electronic component 30, and the like. The light-emitting device 100 may also include a protective film such as an anti-reflection film 70 covering an emission surface (that is, the upper surface of the light-transmissive member 10). The light-transmissive member 10 is a plate-shaped member having a lower surface and an upper surface opposite to the lower surface and is disposed on the light-emitting element 1 such that the lower surface faces a light exit surface 1a of the light-emitting element. In the light-emitting device of the first embodiment, the lower surface of the light-transmissive member 10 is bonded to the light exit surface 1a of the light-emitting element with a light-transmissive bonding member 17. Lateral surfaces of the light-transmissive member 10 are covered with the covering member 60. In the light-emitting device 100, the covering member 60 may further cover lateral surfaces of the light-emitting element 1.

In the light-emitting device 100 of the first embodiment, the light-transmissive member 10 includes a first light-transmissive portion 11 containing phosphor particles and a second light-transmissive portion 12 containing light-diffusing particles, and the upper surface and the lower surface of the light-transmissive member 10 include the first light-transmissive portion 11 and the second light-transmissive portion 12. That is, the upper surface of the light-transmissive member 10 includes an upper surface of the first light-transmissive portion 11 (hereinafter may be referred to as a first upper surface) and an upper surface of the second light-transmissive portion 12 (hereinafter may be referred to as a second upper surface), and the lower surface of the light-transmissive member 10 includes a lower surface of the first light-transmissive portion 11 (hereinafter may be referred to as a first lower surface) and a lower surface of the second light-transmissive portion 12 (hereinafter may be referred to as a second lower surface). The light-transmissive member 10 is disposed on the light-emitting element 1 such that the first lower surface and the second lower surface each face the light exit surface 1a of the light-emitting element 1. Light emitted from the light-emitting element 1 enters the first light-transmissive portion 11 and the second light-transmissive portion 12 from the first lower surface and the second lower surface. The upper surface of the light-transmissive member 10 is the emission surface of the light-emitting device 100. A light-emitting region R of the light-emitting device 100 substantially coincides with the upper surface of the light-transmissive member 10. The emission surface of the light-emitting device 100 includes a first light-emitting region R1 and a second light-emitting region R2 having a lower luminance than in the first light-emitting region R1. In the light-emitting device 100, the first upper surface is the first light-emitting region R1, and the second upper surface is the second light-emitting region R2. The light-emitting device 100 emits first light transmitted through the first light-transmissive portion 11 from the first light-emitting region R1 and second light transmitted through the second light-transmissive portion 12 from the second light-emitting region R2.

The first light-transmissive portion 11 includes a first sintered body 11a containing phosphor particles, and the second light-transmissive portion 12 includes a second sintered body 12a containing light-diffusing particles. Light that has entered the second light-transmissive portion 12 is diffused by the light-diffusing particles in the second sintered body 12a. That is, the second light-transmissive portion 12 contains the second sintered body 12a and thus can reduce the luminance of light emitted from the second upper surface. In the second light-transmissive portion 12, the relative density of the second sintered body 12a is 70% or more and 95% or less. The second sintered body 12a has the above relative density and thus contains 5% or more and 30% or less of voids. The second sintered body 12a can further enhance the light-diffusing effect because of irregular reflection caused by the difference in refractive index between the air present in the voids and the member constituting the second sintered body 12a. By increasing the ratio of the voids contained (that is, reducing the relative density), the light transmittance of the second sintered body 12a is reduced, so that the luminance of light emitted from the second upper surface can be further reduced. By adjusting the value of the relative density (that is, the ratio of voids contained in the sintered body) of the second sintered body 12a, the amount of light emitted from the second light-emitting region R2 can be adjusted.

The light-emitting device of the first embodiment includes the light-transmissive member 10 configured as described above, so that the luminance of the second light-emitting region R2 can be lower than in the first light-emitting region R1 as described below in detail.

The light-transmissive member 10 shown in FIG. 3 will be described below in detail.

The light-transmissive member 10 shown in FIG. 3 is an example, and the light-transmissive member in the light-emitting device according to the present disclosure is not limited to the light-transmissive member 10 shown in FIG. 3.

The light-transmissive member 10 is a plate-shaped member having the lower surface configured to receive light emitted from the light-emitting element and the upper surface opposite to the lower surface. In the example herein, the planar shape of the light-transmissive member 10 is a rectangular shape. The thickness from the lower surface to the upper surface of the light-transmissive member 10 is preferably 50 μm or more from the viewpoint of improvement of mechanical strength and preferably 300 μm or less from the viewpoint of miniaturization of the light-emitting device 100.

As described above, the light-transmissive member 10 includes the first light-transmissive portion 11 and the second light-transmissive portion 12. In the example herein, the first light-transmissive portion 11 is constituted of the first sintered body 11a containing phosphor particles. The second light-transmissive portion 12 includes a first layer 121 and a second layer 122 in this order from the light-emitting element 1 side, and the second layer 122 is constituted of the second sintered body 12a containing light-diffusing particles. The first layer 121 contains phosphor particles. For example, the first layer 121 is a sintered body containing phosphor particles. In the second light-transmissive portion 12, light transmitted through the first layer is diffused by the second layer, and part of the light is emitted from the second light-emitting region R2.

On the upper surface of the light-transmissive member 10, the first light-transmissive portion 11 and the second light-transmissive portion 12 have the same area. The boundary between the first light-transmissive portion 11 and the second light-transmissive portion 12 on the upper surface of the light-transmissive member 10 is located at a position connecting the midpoints of two opposite sides of the rectangular upper surface.

For example, the first sintered body 11a is a sintered body containing phosphor particles used as a wavelength conversion member of an LED and is a light-transmissive member. The second sintered body 12a is a sintered body containing light-diffusing particles and is a light-transmissive and light-diffusing member. Furthermore, setting the relative density of the second sintered body 12a to 70% or more and 95% or less achieves high light-diffusing properties. By adjusting the relative density of the second sintered body 12a and the thickness of the second sintered body 12a in the second light-transmissive portion 12, the second sintered body 12a can be used as a light adjusting member that adjusts the intensity of light emitted from the second light-emitting region R2.

As shown in FIG. 3, for example, the second light-transmissive portion 12 includes the first layer 121 constituted of the first sintered body 11a and the second layer 122 constituted of the second sintered body 12a. In the second light-transmissive portion 12, the light transmittance of the second layer 122 is lower than the light transmittance of the first layer 121. The first layer 121 in the second light-transmissive portion 12 can be integrally formed with the first light-transmissive portion 11. For example, as shown in FIG. 3, the first layer 121 and the first light-transmissive portion 11 can be constituted of the first sintered body 11a. In the case in which the first layer 121 and the first light-transmissive portion 11 are constituted of a single first sintered body 11a, in the light-transmissive member 10, no clear boundary between the first layer 121 and the first light-transmissive portion 11 is visually observed. The thickness of the second layer 122 in the second light-transmissive portion 12 is, for example, 30% or more and 70% or less of the thickness of the second light-transmissive portion 12 in the light-transmissive member 10.

With the light-emitting device 100 including the light-transmissive member 10 constituted as described above, the light-emitting device 100 including the first light-emitting region R1 and the second light-emitting region R2 having a lower luminance than in the first light-emitting region R1 can be provided. A light-emitting device having a high-luminance region and a low-luminance region in an emission surface can thus be obtained.

With the light-transmissive member 10 constituted as described above, the first light-transmissive portion 11 and the second light-transmissive portion 12 can emit light of desired chromaticities at desired luminances.

For example, the first light-transmissive portion 11 can emit light of a desired chromaticity at a desired intensity on the basis of the emission wavelength of the light-emitting element 1, the type and content of the phosphor particles contained in the first light-transmissive portion 11, the thickness of the first light-transmissive portion 11, and the like.

For example, the second light-transmissive portion 12 can emit light of a desired chromaticity at a desired intensity on the basis of the emission wavelength of the light-emitting element 1, the type and content of the phosphor particles contained in the first layer 121, the thickness of the second light-transmissive portion 12, the thickness ratio between the first layer 121 and the second layer 122, the relative density of the second sintered body 12a, the type and content of the light-diffusing particles contained, and the like.

The chromaticities of light emitted from the first light-emitting region R1 and the second light-emitting region R2 may be the same or different.

Specific examples of the constitutions of the first sintered body and the second sintered body will be described below in more detail.

The second sintered body 12a is a light-transmissive member containing light-diffusing particles. The second sintered body 12a is a light-transmissive and light-diffusing white member due to the light-diffusing particles and the voids in the sintered body. The second sintered body 12a has a relative density of 70% or more and 95% or less. The second sintered body 12a has a lower light transmittance of light emitted from the light-emitting element 1 and/or light subjected to wavelength conversion by the phosphor particles than the light transmittance of the first sintered body 11a. The second sintered body 12a can thus be used as a light adjusting member for adjusting the luminance of light emitted from the second light-emitting region R2 in the light-emitting device.

For example, the second sintered body 12a contains a base member made of an inorganic material and light-diffusing particles contained in the base member. The light-diffusing particles are preferably made of an inorganic material.

For example, the base member can be constituted of aluminum oxide, yttrium oxide, zirconium oxide, magnesium oxide, or silicon oxide, preferably aluminum oxide or yttrium oxide, and more preferably mainly composed of aluminum oxide. For example, the light-diffusing particles can be constituted of a rare earth oxide such as yttrium oxide and lanthanum oxide, boron nitride, silicon nitride, titanium oxide, silicon oxide, zirconium oxide, aluminum oxide, magnesium oxide, calcium carbonate, calcium hydroxide, calcium silicate, zinc oxide, barium titanate, potassium titanate, aluminum nitride, boron nitride, mullite, or a combination of these materials and preferably contains yttrium oxide, boron nitride, or zirconium oxide, more preferably yttrium oxide or boron nitride.

As described below in detail, for example, the second sintered body 12a can be sintered to have a desired relative density by spark plasma sintering. The relative density of the second sintered body 12a is a parameter for setting the light transmittance of the second sintered body 12a to a predetermined value.

For example, the second sintered body 12a is produced by mixing an aluminum oxide powder, which is the base member, and an yttrium oxide and/or boron nitride powder, which is the light-diffusing particles, at a predetermined ratio and sintering the mixture. As described above, adding the light-diffusing particles to aluminum oxide and setting the relative density to 70% or more and 95% or less allows the second sintered body 12a to have high light-diffusing properties. The second sintered body is caused to have a predetermined relative density by setting the mixing ratio between the powder serving as the base member and the powder serving as the light-diffusing particles and the sintering conditions in the above ranges. As the base member, yttrium oxide, zirconium oxide, magnesium oxide, or silicon oxide other than aluminum oxide can be used.

As the light-diffusing particles, titanium oxide, silicon oxide, zirconium oxide, aluminum oxide, magnesium oxide, calcium carbonate, calcium hydroxide, calcium silicate, zinc oxide, barium titanate, potassium titanate, aluminum nitride, silicon nitride, mullite, or a combination of these materials can be used other than rare earth oxides such as yttrium oxide and lanthanum oxide and boron nitride (BN).

The first sintered body 11a is a light-transmissive member containing phosphor particles and is used in the light-emitting device as a wavelength conversion member that performs wavelength conversion of light from the light-emitting element and emits the light to the outside. The first sintered body 11a is light-transmissive and has an external color (such as yellow) of the phosphor particles contained. The first sintered body 11a has a light transmittance of light emitted from the light-emitting element 1 and/or light subjected to wavelength conversion by the phosphor particles of 60% or more, preferably 70% or more, more preferably 80% or more. The first sintered body 11a preferably has a high relative density in order to have a high light transmittance. For example, the relative density of the first sintered body 11a is preferably 95% or more and 99% or less. A highly light-transmissive sintered body can thus be provided, and wavelength conversion of light entering the first sintered body 11a can be efficiently performed in the crystalline phase of the phosphor.

For example, the first sintered body 11a can be produced by mixing phosphor particles in an inorganic material powder such as aluminum oxide serving as the base member of the sintered body and sintering the mixture. The inorganic material powder is not required, and for example, only the phosphor particles may be sintered by being calcined with a sintering aid. Examples of the phosphor contained in the first sintered body 11a include yttrium-aluminum-garnet (YAG) based phosphors (such as (Y,Gd)₃(Al,Ga)₅O₁₂:Ce), lutetium-aluminum-garnet based phosphors (such as Lu₃(Al,Ga)₅O₁₂:Ce), terbium-aluminum-garnet based phosphors (such as Tb₃(Al,Ga)₅O₁₂:Ce), CCA based phosphors (such as Ca₁₀(PO₄)₆C₁₂:Eu), SAE based phosphors (such as Sr₄Al₁₄O₂₅:Eu), chlorosilicate based phosphors (such as Ca₈MgSi₄O₁₆Cl₂:Eu), silicate based phosphors (such as (Ba,Sr,Ca,Mg)₂SiO₄:Eu), oxynitride based phosphors such as β-SiAlON based phosphors (such as (Si,Al)₃(O,N)₄:Eu) and α-SiAlON based phosphors (such as Ca(Si,Al)₁₂(O,N)₁₆:Eu), nitride based phosphors such as LSN based phosphors (such as (La,Y)₃Si₆N₁₁:Ce), BSESN based phosphors (such as (Ba,Sr)₂Si₅N₈:Eu), SLA based phosphors (such as SrLiAl₃N₄:Eu), CASN based phosphors (such as CaAlSiN₃:Eu), and SCASN based phosphors (such as (Sr,Ca)AlSiN₃:Eu), fluoride based phosphors such as KSF based phosphors (such as K₂SiF₆:Mn), KSAF based phosphors (such as K₂(Si₁₋ₓAlₓ)F₆₋ₓ:Mn, where x satisfies 0<x<1), and MGF based phosphors (such as 3.5MgO·0.5MgF₂·GeO₂:Mn), quantum dots having the perovskite structure (such as (Cs,FA,MA)(Pb,Sn)(F,Cl,Br,I)₃, where FA and MA respectively represent formamidinium and methylammonium), group II-VI quantum dots (such as CdSe), group III-V quantum dots (such as InP), and quantum dots having the chalcopyrite structure (such as (Ag,Cu)(In,Ga)(S,Se)₂).

The light-transmissive member 10 of the first embodiment includes the first light-transmissive portion 11 and the second light-transmissive portion 12 constituted as described above. Accordingly, in the light-emitting region R of the light-emitting device 100 of the first embodiment, the luminance of the second light-emitting region R2 can be lower than the luminance of the first light-emitting region R1.

In the case in which the light-emitting device 100 including the first light-emitting region R1 and the second light-emitting region R2 different from each other in luminance on the emission surface as described above is used for a vehicle headlight, it is possible to locate the high-luminance region in a desired region of the irradiated region. It thus becomes easy to obtain desired light distribution without using a complicated optical design such as a reflector and a lens. This enables miniaturization of the headlight and enhances design qualities of the headlight.

In the light-transmissive member 10, the first light-transmissive portion 11 and the second light-transmissive portion 12 may be in contact with or separated from each other. In the light-transmissive member 10, the statement that “the first light-transmissive portion 11 and the second light-transmissive portion 12 are in contact with each other” includes the case in which the first light-transmissive portion 11 and the second light-transmissive portion 12 as separate constituent members are in contact with each other and the case in which the first light-transmissive portion 11 and the second light-transmissive portion 12 are different regions of a single constituent member. The statement that “the first light-transmissive portion 11 and the second light-transmissive portion 12 include different regions of the same constituent member” includes, for example, the case in which the first light-transmissive portion 11 and the first layer of the second light-transmissive portion 12 are integrally formed as the first sintered body. In the second light-transmissive portion 12, the first layer 121 and the second layer 122 may be in contact with or separated from each other.

If the first light-transmissive portion 11 and the second light-transmissive portion 12 in the light-transmissive member 10 are in contact with each other, in the light-emitting region R of the light-emitting device 100, the first light-emitting region R1 and the second light-emitting region R2 having different luminances and/or chromaticities can be adjacent to each other.

In this case, if the interface between the first sintered body 11a in the first light-transmissive portion 11 and the second sintered body 12a in the second light-transmissive portion 12 includes a substantially perpendicular plane continuous with the upper surface of the light-transmissive member 10, the difference in luminance between the first light-emitting region R1 and the second light-emitting region R2 near the boundary between the first light-transmissive portion 11 and the second light-transmissive portion 12 can be increased. In other words, the luminance can be caused to change abruptly near the boundary between the first light-transmissive portion 11 and the second light-transmissive portion 12.

In the case in which the first light-transmissive portion 11 and the second light-transmissive portion 12 are in contact with each other in the light-transmissive member 10, if the boundary between the first sintered body 11a in the first light-transmissive portion 11 and the second sintered body 12a in the second light-transmissive portion 12 is inclined with respect to the upper surface of the light-transmissive member 10, an abrupt change in luminance near the boundary can be reduced. Alternatively, for example, the boundary between the first sintered body 11a and the second sintered body 12a may be curved as shown in FIG. 3. An abrupt change in luminance near the boundary can be reduced also in this manner.

That is, the change in luminance near the boundary can be set by appropriately adjusting the constitution near the boundary between the first light-transmissive portion 11 and the second light-transmissive portion 12 in accordance with the specifications.

Configurations of the light-emitting device of the first embodiment will be specifically described below.

### Light-Emitting Element 1

The light-emitting element 1 has the upper surface serving as the main light exit surface 1a of the light-emitting element 1, the lower surface opposite to the upper surface, and lateral surfaces continuous with the upper surface and the lower surface. For the light-emitting element 1, a light-emitting diode can be used. The light-emitting element 1 includes a semiconductor structure body L1 and at least a pair of positive and negative element electrodes 1e. The term “element electrode 1e” in the present specification is used in the case in which distinction between positive and negative is not particularly required for the description. In the case in which distinction between positive and negative is required, for example, the terms “p-electrode” and “n-electrode” are used. The semiconductor structure body L1 includes an n-side semiconductor layer, a p-side semiconductor layer, and an active layer sandwiched between the n-side semiconductor layer and the p-side semiconductor layer and, for example, is disposed on a supporting substrate S1. The active layer may have a single quantum well (SQW) structure or a multiple quantum well (MQW) structure including a plurality of well layers. For example, the semiconductor structure body includes a plurality of semiconductor layers made of a nitride semiconductor. The nitride semiconductor includes all semiconductors having the compositions represented by the chemical formula InₓAl_{y}Ga_{1-x-y}N (0≤x, 0≤y, and x+y≤1) where the composition ratios x and y vary in the respective ranges. The peak emission wavelength of the active layer can be appropriately selected according to the purpose. For example, the active layer is configured to emit visible light or ultraviolet light.

The form of the semiconductor structure body L1 in which the semiconductor structure body L1 includes a single light-emitting portion including the n-side semiconductor layer, the active layer, and the p-side semiconductor layer is being described as an example in the first embodiment, but as described referring to an embodiment described below, a plurality of light-emitting portions each including an n-side semiconductor layer, an active layer, and a p-side semiconductor layer may be included. The expression “the same peak emission wavelength” includes the case in which there are variations of approximately several nanometers. The combination of peak emission wavelengths of a plurality of light-emitting portions can be appropriately selected. In the case in which the semiconductor structure body includes two light-emitting portions, examples of the combination of light emitted from the respective light-emitting portions include blue light and blue light, green light and green light, red light and red light, ultraviolet light and ultraviolet light, blue light and ultraviolet light, blue light and green light, blue light and red light, and green light and red light. In the case in which the semiconductor structure body includes three light-emitting portions, examples of the combination of light emitted from the respective light-emitting portions include blue light, green light, and red light. Each light-emitting portion may include one or more well layers having a peak emission wavelength different from the peak emission wavelength of other well layers. The shape, size, and the like of the light-emitting element 1 can be selected from various choices according to the purpose.

The light-emitting element 1 may include the supporting substrate S1 supporting the semiconductor structure body L1. Examples of the supporting substrate S1 include insulating substrates such as sapphire and spinel (MgAl₂O₄) substrates and nitride semiconductor substrates such as InN, AlN, GaN, InGaN, AlGaN, and InGaAlN substrates. In the case in which light emitted from the light-emitting portion is extracted through the supporting substrate (that is, in the case in which the supporting substrate constitutes the light exit surface 1a), a light-transmissive material is preferably used for the supporting substrate. The light-emitting element 1 does not necessarily include the supporting substrate S1.

The light-emitting element 1 includes an element electrode 1e at least on the lower surface of the light-emitting element 1. For example, in the light-emitting element 1, at least one pair of positive and negative element electrodes are disposed on the same side of the semiconductor structure body. The positive and negative element electrodes can be disposed in consideration of the position of wiring of the wiring board 40 and the like. For example, the element electrodes 1e of the light-emitting element 1 are connected to wiring 42 of the wiring board 40 through electroconductive bonding members. Examples of the electroconductive bonding members include eutectic solder, electroconductive paste, and bumps. The element electrodes 1e of the light-emitting element 1 may be directly bonded to the wiring 42 without electroconductive members.

### Board 40

The board 40 is a plate-shaped member including a base 41 and the wiring 42 disposed at least on the upper surface of the base 41.

For example, the base 41 can be constituted of an insulating material such as glass epoxy, a resin, and a ceramic, a semiconductor material such as silicon, or an electroconductive material such as a metal. Among these materials, a ceramic, which has high resistance to heat and light, can be suitably used. Examples of the ceramic include aluminum oxide, aluminum nitride, silicon nitride, and LTCC. Alternatively, a composite material of these insulating materials, semiconductor materials, and electroconductive materials can be used. In the case in which a semiconductor material or an electroconductive material such as a metal is used as the base 41, the wiring 42 can be disposed on the upper surface and the lower surface of the base 41 with an insulating layer therebetween.

The wiring 42 includes first wiring 421 and second wiring 422 disposed at least on the upper surface of the base 41. The wiring 42 may further include an external connection terminal disposed on the lower surface opposite to the upper surface. In this case, for example, the first wiring 421 and the second wiring 422 disposed on the upper surface of the base 41 may be connected to the external connection terminal through relay wiring disposed inside the base 41 or on a lateral surface of the base 41. Examples of the material of the wiring 42 include metals such as Fe, Cu, Ni, Al, Ag, Au, Pt, Ti, W, and Pd and alloys containing at least one of these metals.

### Electronic Component 30

For example, the electronic component 30 is a protective element. For example, the protective element is a Zener diode. For example, the electronic component 30 is connected to the first wiring 421 and the second wiring 422 via electroconductive members. The light-emitting device 100 may not include the electronic component 30.

### Covering Member 60

The covering member 60 is an insulating member disposed on the board 40 to expose the upper surface of the light-transmissive member 10 and cover the lateral surfaces of the light-transmissive member 10 and the lateral surfaces of the light-emitting element 1. In the case in which the light-emitting device 100 includes the electronic component 30, the covering member 60 preferably covers the electronic component 30.

The covering member 60 preferably has light-shielding properties (specifically, light-reflective properties and/or light-absorbing properties), particularly preferably has light-reflective properties. For example, the covering member 60 contains light-reflective particles and a base material. The light-reflective particles reflects light emitted from the light-emitting element. Examples of the material of the light-reflective particles include titanium oxide, silicon oxide, zirconium oxide, boron nitride, and aluminum oxide. The light-reflective particles can contain one or more types of these materials. The base material may contain an organic material, an inorganic material, or both an organic material and an inorganic material. A resin can be used as the organic material. An alkali metal silicate can be used as the inorganic material.

Among these materials, in the viewpoint of reliability, the covering member 60 is preferably constituted of an inorganic member. For example, the covering member 60 can be constituted of a mixture containing boron nitride and an alkali metal silicate. The mixture can be produced by mixing a mixed powder of a boron nitride powder and a silicon oxide powder with a solution of an alkali (such as potassium hydroxide) and heating and hardening the product. In the case in which the solution of an alkali is potassium hydroxide, the heating and hardening results in formation of potassium silicate, which is an alkali metal silicate, by the reaction of silicon oxide and potassium hydroxide. Boron nitride is a member that can reduce contraction of the mixture at the time of the heating and hardening. Aluminum oxide can be used in place of boron nitride.

The concentration of the light-reflective substance in the covering member 60 is preferably, for example, 60 mass % or more and 70 mass % or less. The concentration of the light-reflective substance refers to the proportion of the light-reflective substance in the covering member 60 containing the light-reflective substance. For example, the reflectance of the covering member 60 is preferably 70% or more, more preferably 80% or more. The reflectance refers to the reflectance at a peak emission wavelength of light emitted from the light-emitting element 1.

### Anti-Reflection Film

The light-emitting device 100 preferably includes the anti-reflection film 70 covering the emission surface. The anti-reflection film 70 is a light-transmissive thin film that collectively covers the first light-transmissive portion 11 and the second light-transmissive portion 12. If the light-emitting device 100 includes the anti-reflection film 70 covering the emission surface, transmission of light from the outside can be reduced while the emission efficiency of light from the light-emitting element 1 is improved. For the anti-reflection film 70, a single layer or multilayer film of a light-transmissive film such as SiO₂ and ZrO₂ can be used. The anti-reflection film 70 can cover the boundary between the first sintered body 11a and the second sintered body 12a on the upper surface of the light-transmissive member 10 to improve adhesion between the sintered bodies.

A method of manufacturing the light-emitting device of the first embodiment will be described below.

The method of manufacturing the light-emitting device according to the first embodiment includes providing a light-emitting element having an upper surface serving as a light exit surface, providing a light-transmissive member including a first light-transmissive portion having a first light incident surface and a first light exit surface and a second light-transmissive portion having a second light incident surface and a second light exit surface and having a transmittance of light lower than in the first light-transmissive portion, and disposing the light-transmissive member on or above the light-emitting element to allow the first light incident surface and the second light incident surface to face the light exit surface of the light-emitting element.

Each of these steps will be described below.

### (1) Step ST1 of Providing Light-Emitting Element

In the step of providing a light-emitting element, a light-emitting element having an upper surface serving as a light exit surface is provided.

For example, in the step of providing a light-emitting element, a light-emitting element is provided by providing a supporting substrate, disposing a semiconductor structure body including at least one light-emitting portion on the supporting substrate, and disposing at least a pair of positive and negative element electrodes on a surface opposite to the supporting substrate side of the semiconductor structure body. Here, the light exit surface of the light-emitting element is a surface on the supporting substrate side, and the light-transmissive member described below is disposed on the supporting substrate. Step ST1 of providing a light-emitting element may include a step of removing the supporting substrate. In this case, the light exit surface of the light-emitting element is a surface opposite to the side of the semiconductor structure body on which the element electrodes are disposed. The light-emitting element may be provided by purchasing, transfer, or the like.

### (2) Step ST2 of Providing Light-Transmissive Member

In the step of providing a light-transmissive member, a light-transmissive member including a first light-transmissive portion having a first light incident surface and a first light exit surface and a second light-transmissive portion having a second light incident surface and a second light exit surface and having a transmittance of light lower than in the first light-transmissive portion is provided.

Here, for example, Step ST2 of providing a light-transmissive member includes:
Step ST2-1 of providing a light-transmissive substrate containing an inorganic material and having a first main surface and a second main surface opposite to the first main surface;
Step ST2-2 of forming a recess in the first main surface of the light-transmissive substrate;
Step ST2-3 of forming in the recess a sintered portion having a lower light transmittance than the light transmittance of the light-transmissive substrate by disposing in the recess a powder containing (i) a base member made of an inorganic material and (ii) light-diffusing particles made of an inorganic material and sintering the powder; and
Step ST2-4 of dividing the light-transmissive substrate including the sintered portion to form a light-transmissive member including a first light-transmissive portion made of a portion of the light-transmissive substrate and a second light-transmissive portion including a portion of the sintered portion and a portion of the light-transmissive member.

Each of these steps will be specifically described below.

For example, in Step ST2-1, the light-transmissive substrate is provided by mixing phosphor particles with light-transmissive inorganic particles serving as the base member of the light-transmissive substrate and sintering the mixture to produce the light-transmissive substrate. For example, the inorganic particles serving as the base member are aluminum oxide, and the phosphor particles are YAG based phosphor particles. The inorganic particles are not required, and only the phosphor particles may be sintered. For example, a light-transmissive substrate having high heat dissipation performance can be produced by mixing a powder containing highly thermally conductive inorganic particles such as aluminum oxide as the base member and phosphor particles and sintering the mixture. For example, 50% or more, such as 80% to 95%, of aluminum oxide can be contained in a powder containing a YAG based phosphor and aluminum oxide, so that a light-transmissive substrate having high heat dissipation performance can be manufactured. With respect to the total of the YAG based phosphor and aluminum oxide, 20% or less, such as 10% to 20%, of aluminum oxide can be contained, so that a light-transmissive substrate having a high wavelength conversion rate of incident light can be manufactured while maintaining comparatively high heat dissipation performance. A small amount, such as about 5%, of light-diffusing particles such as YAlO₃ can be mixed as the light-diffusing material with a powder containing phosphor particles such as a YAG based phosphor, and the mixture can be sintered. A light-transmissive substrate exhibiting a good light-diffusing efficiency can thus be manufactured. As described above, the types and mixing ratio of the phosphor and another inorganic material can be selected from various choices according to the purpose.

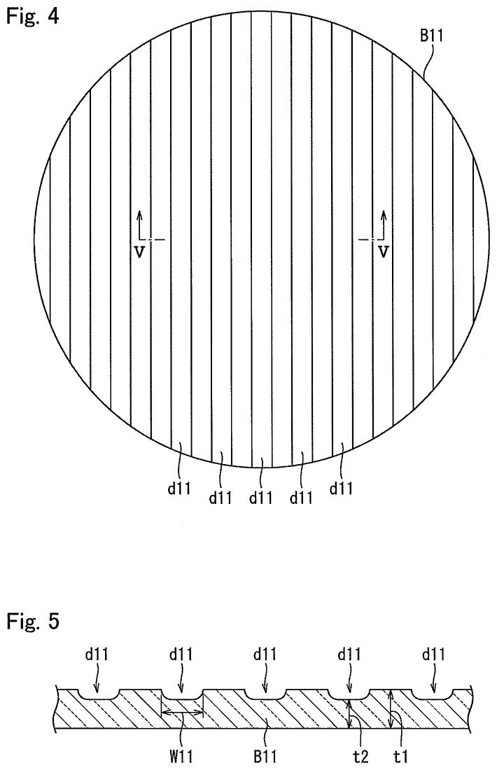

As shown in FIGS. 4 and 5, for example, the light-transmissive substrate has the shape of a wafer with a circular outer shape. For example, the diameter of the light-transmissive substrate is about 4 inches, and a thickness t1 is about 0.5 mm. For example, the light-transmissive substrate can be produced by using a mixture of an inorganic material powder and a phosphor powder as raw materials and slicing a cylindrical sintered body obtained by a method disclosed in Japanese Unexamined Patent Application Publication No. 2018-172628 into the predetermined thickness t1 using a wire saw or the like.

Here, at the time of mixing the raw materials, that is, mixing the inorganic particles and the phosphor particles, an organic material such as a binder may be added, and instead of using particles of the phosphor itself, particles serving as the raw material of the phosphor may be used and sintered to have a predetermined phosphor structure as the phosphor particles. Molding may be performed in two or more steps such as press molding using a mold and then pressing by cold isostatic pressing (CIP) or the like. The sintering may be performed in a vacuum, the atmosphere, or an inert gas atmosphere. The light-transmissive substrate may be provided by purchasing, transfer, or the like.

In Step ST2-2, recesses d11 are formed in the first main surface of a light-transmissive substrate B11.

As shown in FIGS. 4 and 5, for example, the recesses d11 are formed in the first main surface of the light-transmissive substrate B11 in the form of grooves. A width (width of grooves) W11 of the recesses d11 is twice or more as large as the width of the second light-transmissive portion 12. Specifically, the width is the total of the width twice as large as the width of the second light-transmissive portion 12 and the width to be removed (such as the width of a blade to be used) when the light-transmissive substrate is divided in Step ST2-4 described below. The interval between adjacent recesses d11 is twice or more as large as the width of the first light-transmissive portion 11. Specifically, the width is the total of the width twice as large as the width of the first light-transmissive portion 11 and the width to be removed (such as the width of a blade to be used) at the time of the division in Step ST2-4 described below. The depth (t1-t2) of the recesses d11 is the total of the thickness of the second sintered body in the second light-transmissive portion 12 and the margin for grinding the obtained light-transmissive substrate B11 to a predetermined thickness in Step ST2-3 described below.

A lateral surface of the recess d11 is preferably inclined so that the width of the opening will be widened upward. In other words, the angle formed by the lateral surface of the recess d11 and the first main surface defining the recess d11 is preferably 90 degrees or more. Variations in the density of the sintered body to be formed in the recess d11 can thus be reduced. In order to reduce the variations in the density of the sintered body, the lateral surface of the recess d11 is not required to be entirely inclined, and as shown in FIG. 5, the lateral surface of the recess d11 is only required to be partially curved or inclined. As shown in FIG. 4, upper edges of the recesses d11 define straight lines in the first main surface.

The extent of the inclination or curvature and the inclined or curved portion of the lateral surface of the recess d11 can be set so that the change in luminance near the boundary between the first light-emitting region and the second light-emitting region will be a desired change.

In Step ST2-3, a powder containing (i) a base member made of an inorganic material and (ii) light-diffusing particles made of an inorganic material is disposed in the recess, and the powder is sintered to form in the recess the second sintered body as a sintered portion having a lower light transmittance than the light transmittance of the light-transmissive substrate.

For example, the second sintered body is sintered by spark plasma sintering (SPS).

Formation of the sintered portion (second sintered body) by spark plasma sintering will be described below.

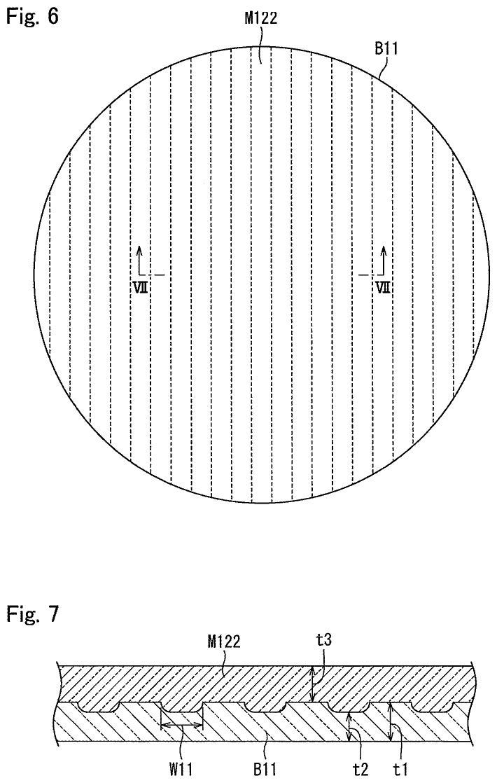

First, inorganic particles intended to be the base member of the sintered portion (second sintered body) after sintering and light-diffusing particles intended to be the light-diffusing particles of the sintered portion (second sintered body) after sintering are mixed together. As shown in FIG. 6 and FIG. 7, a mixture M122 is disposed on the first main surface of the light-transmissive substrate B11. The mixture M122 is disposed such that the mixture M122 is filled into the recesses d11 and covers the entirety of first main surface. A thickness t3 (height from the first main surface of the light-transmissive substrate B11) of the mixture M122 covering the first main surface is preferably twice or more as large as the depth (t1-t2) of the recesses d11. Variations in the density of the second sintered body to be formed in the recesses d11 can thus be reduced.

Using a spark plasma sintering apparatus, voltage is applied to the light-transmissive substrate B11 on which the mixture M122 is disposed in a state in which pressure is applied from the upper surface of the mixture M122 and the lower surface of the light-transmissive substrate B11 to form the sintered body. The pressure applied when the sintered body is formed is, for example, 10 to 50 MPa. The input current when the sintered body is formed can be appropriately adjusted according to the size of the sintered body to be obtained.

A spark plasma sintering apparatus 500 used for spark plasma sintering is an apparatus that inputs a large, pulsed current to the mixture M122 at a low voltage to sinter a powder with high energy of spark plasma generated in a moment by the spark discharge phenomenon and is configured as follows.

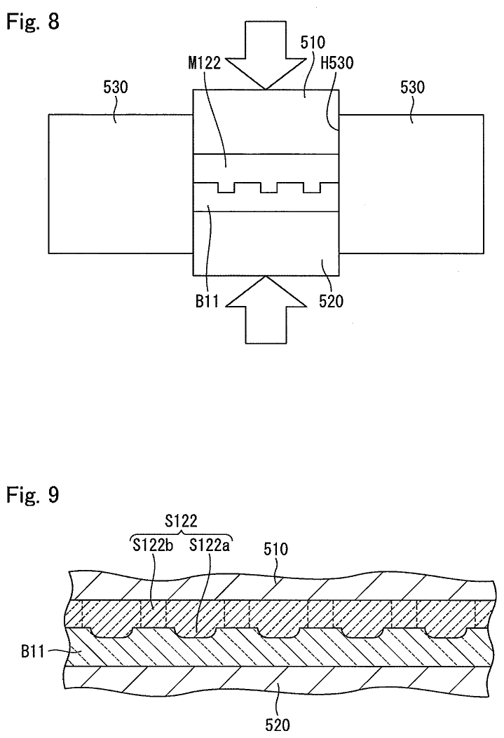

As shown in FIG. 8, for example, the spark plasma sintering apparatus 500 includes an upper punch 510, a lower punch 520, and a sintering die 530 made of carbon. The sintering die 530 has a cylindrical through hole H530 in which the light-transmissive substrate is to be inserted, and the light-transmissive substrate inserted into the through hole H530 is sandwiched between the upper punch 510 and the lower punch 520 in the through hole H530 and pressurized. At least one of the upper punch 510 and the lower punch 520 can move upward and downward in the through hole of the sintering die 530. The upper punch 510 is provided with an upper electrode, the lower punch 520 is provided with a lower electrode, and voltage is applied to a powder mixture sandwiched between the upper electrode and the lower electrode.

Using the spark plasma sintering apparatus 500 configured as described above, voltage is applied to the light-transmissive substrate on which the powder mixture is sandwiched between the upper punch 510 and the lower punch 520 in the through hole H530 to sinter the powder mixture, and the mixture is then cooled to form a sintered body S122 on the light-transmissive substrate B11.

The sintered body S122 on the light-transmissive substrate B11 formed as described above constitutes the second sintered body through the steps described below. Accordingly, the conditions of the spark plasma sintering apparatus 500 are set so that the sintered body S122 has a predetermined relative density (such as a predetermined relative density in the range of 70% or more and 95% or less) required for the second sintered body.

The relative density of a sintered body S122a on the recess d11 in the sintered body S122 tends to be smaller than the relative density of a sintered body S122b on the first main surface between adjacent recesses d11. In this case, the sintered body S122a constitutes the second sintered body, and the conditions of the spark plasma sintering apparatus 500 are set so that the sintered body S122a has a desired relative density.

For example, the spark plasma sintering apparatus 500 can be provided in a chamber in which the atmosphere at the time of sintering can be adjusted. With this constitution, the inside of the chamber can be appropriately set to a vacuum, the atmosphere, or an inert gas atmosphere such as nitrogen and argon. After the sintered body is formed, annealing may be further performed. For example, the annealing can be performed in the atmosphere, nitrogen, or hydrogen/nitrogen mixed gas. In particular, in the case in which the base member is an oxide, annealing in the atmosphere or oxygen circulation atmosphere is preferably performed at a temperature of about 1,000° C. to 1,500° C. for 1 to 5 hours. Carbon adhering to or entering the spark plasma sintering apparatus 500 can thus be removed.

For example, in the case in which the second sintered body is constituted of aluminum oxide particles serving as the base member and an yttrium oxide and/or boron nitride powder serving as the light-reflective particles, the conditions of spark plasma sintering are, for example, a peak temperature of 1,000° C. to 1,500° C., an applied pressure of 10 to 50 MPa, and a retention time of about 5 to 30 minutes. The second sintered body having a predetermined relative density can thus be obtained.

After the sintered body S122 is formed on the light-transmissive substrate B11, as shown in FIG. 11, the sintered body S122b on the first main surface is removed by grinding or the like. The sintered body S122 is further ground so that the thickness of the sintered body S122a in the recess d11 will be a desired thickness t122 of the second sintered body 12a of the light-transmissive member 10 to be obtained. At this time, the surface of the first main surface side of the light-transmissive substrate B11 may be ground at the same time. The lower surface of the light-transmissive substrate B11 may be ground as necessary to adjust the thickness of the light-transmissive substrate B11 between the recesses d11 constituting the first light-transmissive portion 11 to a predetermined thickness t11. Grinding of the sintered body S122 and grinding of the lower surface of the light-transmissive substrate B11 may be performed simultaneously or separately. Grinding of the light-transmissive substrate B11 may be omitted by providing the light-transmissive substrate B11 having a thickness of t11 when the light-transmissive substrate B11 is provided.

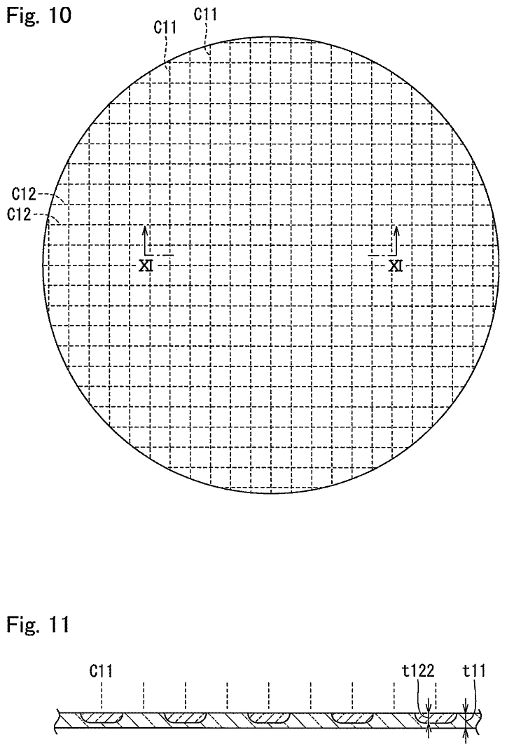

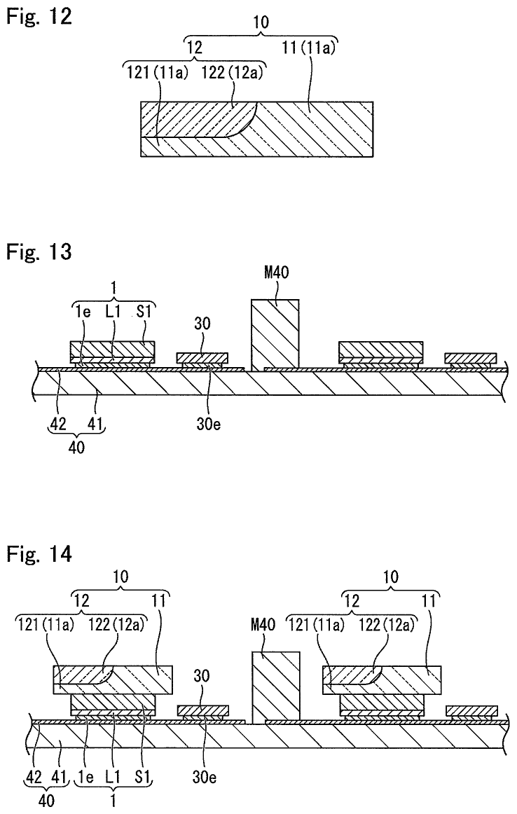

In Step ST2-4, as shown in FIG. 10 and FIG. 11, the light-transmissive substrate on which the sintered portions S122 have been formed is divided along dividing lines C11 and C12. The light-transmissive member including the first light-transmissive portion made of a portion of the light-transmissive substrate and the second light-transmissive portion including a portion of the sintered portion and a portion of the light-transmissive substrate is thus formed.

The dividing lines C11 are located on the center lines of the recesses d11 in the longitudinal direction, and the dividing lines C12 are orthogonal to the dividing lines C11.

The light-transmissive member 10 is produced through the above steps.

The method of manufacturing the light-emitting device of the first embodiment includes the step of producing the light-transmissive member 10 described above and may further include the following steps.

### (3) Step of Providing Collective Substrate

In a step of providing a collective substrate, a collective substrate including a plurality of substrate regions each constituting the wiring board 40 of the light-emitting device 100 is provided. For example, the substrate regions are arranged in a matrix. For example, the collective substrate is provided by first providing a plate-shaped base (that is, a collective body of bases 41) such as glass epoxy, a resin, and a ceramic. Subsequently, the first wiring 421 and the second wiring 422 are formed on each substrate region of the base. The first wiring 421 and the second wiring 422 can be formed by a known method such as plating, vapor deposition, and sputtering. A collective substrate provided with wiring in advance may be provided by purchasing, transfer, or the like.

### (4) Step of Disposing Light-Emitting Element 1

In a step of disposing the light-emitting element 1, the light-emitting element 1 is disposed in each substrate region of the collective substrate. For example, as shown in FIG. 13, the light-emitting element 1 is disposed at a predetermined position such that the element electrodes 1e face the wiring 42 in each substrate region. For example, the wiring 42 and the element electrode 1e can be bonded together with an electroconductive bonding member. The electronic component 30 is disposed at a predetermined position as necessary in the same manner.

The member denoted by the reference numeral M40 in FIG. 13 and other drawings is a mask provided for exposing the wiring 42 from the covering member 60.

### (5) Step of Disposing Light-Transmissive Member 10

In a step of disposing the light-transmissive member 10, as shown in FIG. 14, the light-transmissive members 10 are disposed to face the light exit surfaces of the respective light-emitting elements 1 disposed on the collective substrate. For example, the light-emitting element 1 and the light-transmissive member 10 can be bonded with a known adhesive member such as a light-transmissive resin. The light-transmissive member 10 may be directly bonded to a supporting substrate 15 by compression, surface-activated bonding, atomic diffusion bonding, hydroxy group bonding, or the like.

The step of disposing the light-transmissive member 10 may be performed before the step of disposing a light-emitting element. In this case, in the step of disposing the light-emitting element 1 described above, the light-emitting element 1 on which the light-transmissive member 10 has been disposed is disposed on the collective substrate.

### (6) Step of Disposing Covering Member 60

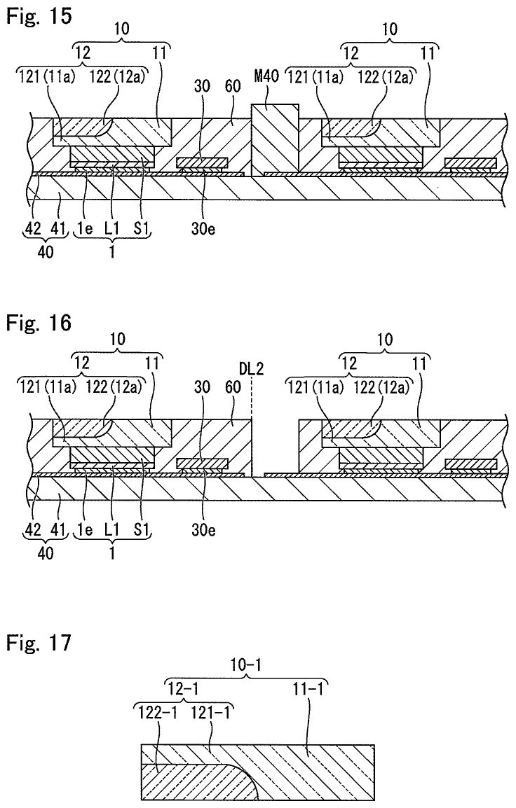

In a step of disposing the covering member 60, as shown in FIG. 15, an unhardened covering member 60 is disposed to cover the lateral surfaces of the light-emitting element 1 and the light-transmissive member 10 disposed on the collective substrate such that the upper surface of the light-transmissive member 10 serving as the emission surface of the light-emitting device is exposed. For example, the covering member 60 can be disposed by potting. After that, the unhardened covering member 60 is hardened. The covering member 60 can be disposed by compression molding, transfer molding, or the like.

After the covering member 60 is disposed (preferably after hardening), the mask M40 is removed as shown in FIG. 16. The mask M40 may be removed after singulation described below.

In the step of disposing the covering member 60, instead of using the mask M40, a wall holding the covering member 60 may be disposed on the collective substrate. For example, a resin having a higher hardness than the resin constituting the covering member 60 can be used for the wall. Alternatively, the wall may be a portion of the base 41, and for example, the wiring board 40 may have a structure having a recess in which the light-emitting element is disposed.

(7) Step of Singulation into Individual Light-Emitting Devices 100

In a step of singulation into individual light-emitting devices 100, the collective substrate is divided into individual light-emitting devices 100 with a blade or the like along the outer edges (such as the separation line indicated by the broken line DL2 in FIG. 16) of the individual substrate regions.

The light-emitting device 100 of the first embodiment is produced through the above steps.

In the method of manufacturing the light-emitting device 100 of the first embodiment, the chromaticity and emission spectrum of light emitted from the upper surface of the first light-transmissive portion 11, the chromaticity and emission spectrum of light emitted from the upper surface of the second light-transmissive portion 12, the luminance in the first light-emitting region R1, and the luminance in the second light-emitting region R2 are set by selecting the type of the light-emitting element 1 and appropriate materials for the materials of the respective members described above and appropriately setting various parameters such as the size of each member.

The light-emitting device 100 according to the first embodiment in the present disclosure has been described above. However, the first embodiment in the present disclosure is not limited to the specific examples described above, and various modifications are possible.

Modified examples of the light-emitting device 100 according to the first embodiment in the present disclosure will be described below.

### Modified Example 1

FIG. 17 is a schematic cross-sectional view of a light-transmissive member 10-1 used for a light-emitting device of Modified Example 1.

In the light-emitting device of Modified Example 1, the constitution other than the light-transmissive member 10-1 is the same as in the light-emitting device of the first embodiment.

As shown in FIG. 17, in the light-transmissive member 10-1 of the light-emitting device of Modified Example 1, the first layer and the second layer in a second light-transmissive portion 12-1 is upside down compared with the light-emitting device 100 according to the first embodiment.

A first layer 121-1 and a second layer 122-1 in the second light-transmissive portion 12-1 are respectively constituted in the same manner as the first layer 121 and the second layer 122 in the second light-transmissive portion 12 of the first embodiment.

A first light-transmissive portion 11-1 in the light-emitting device of Modified Example 1 is constituted in the same manner as the first light-transmissive portion 11 in the light-emitting device 100 of the first embodiment.

As with the light-emitting device 100 of the first embodiment, with the light-emitting device of Modified Example 1 constituted as described above, a light-emitting device having a high-luminance region (first light-transmissive portion 11-1) and a low-luminance region (second light-transmissive portion 12-1) in the emission surface can be obtained. The change in luminance between the first light-emitting region R1 and the second light-emitting region R2 near the boundary between the first light-transmissive portion 11-1 and the second light-transmissive portion 12-1 can be made gentle because the boundary between the first light-transmissive portion 11-1 and the second layer 122-1 of the second light-transmissive portion 12-1 in the light-transmissive member 10-1 is located on the lower surface side of the light-transmissive member 10-1.

### Modified Example 2

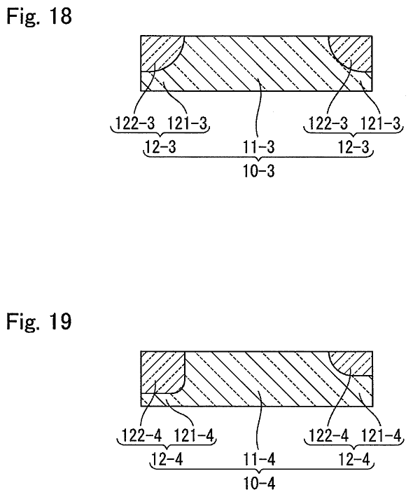

FIG. 18 is a schematic cross-sectional view of a light-transmissive member 10-3 used for a light-emitting device of Modified Example 2.

In the light-emitting device of Modified Example 2, the constitution other than the light-transmissive member 10-3 is the same as in the light-emitting device of the first embodiment.

As shown in FIG. 18, in the light-transmissive member 10-3 of the light-emitting device of Modified Example 2, two second light-transmissive portions 12-3 are located on both sides of a first light-transmissive portion 11-3.

First layers 121-3 and second layers 122-3 in the second light-transmissive portions 12-3 on both sides of the first light-transmissive portion 11-3 are constituted in the same manner as the first layer 121 and the second layer 122 in the second light-transmissive portion 12 of the first embodiment.

The first light-transmissive portion 11-3 in the light-emitting device of Modified Example 2 is constituted in the same manner as the first light-transmissive portion 11 in the light-emitting device 100 of the first embodiment.

With the light-emitting device of Modified Example 2 constituted as described above, a light-emitting device having one high-luminance region and two low-luminance regions sandwiching the high-luminance region in the emission surface can be provided.

### Modified Example 3

FIG. 19 is a schematic cross-sectional view of a light-transmissive member 10-4 used for a light-emitting device of Modified Example 3.

In the light-emitting device of Modified Example 3, the constitution other than the light-transmissive member 10-4 is the same as in the light-emitting device of the first embodiment.

As shown in FIG. 19, the light-transmissive member 10-4 in the light-emitting device of Modified Example 3 is the same as in Modified Example 2 in that two second light-transmissive portions 12-4 are located on both sides of a first light-transmissive portion 11-4, but the thickness of a second layer 122-4 in the second light-transmissive portion 12-4 on one side of the first light-transmissive portion 11-4 is different from the thickness of a second layer 122-4 in the second light-transmissive portion 12-4 on the other side of the first light-transmissive portion 11-4. Light with different luminances can thus be emitted from the light-transmissive portions 12-4 to the outside of the two portions. The constitution other than the difference in thickness between the second layers 122-4 of the two second light-transmissive portions 12-4 is the same as in Modified Example 2.

With the light-emitting device of Modified Example 3 constituted as described above, a light-emitting device having one high-luminance region, and a low-luminance region and a medium-luminance region sandwiching the high-luminance region in the emission surface can be provided. The medium-luminance region is a region that emits light with a luminance between the luminances of light emitted from the high-luminance region and light emitted from the low-luminance region. In the medium-luminance region in the light-emitting device of Modified Example 3, the thickness of the second layer 122-4 is greater than in the low-luminance region.

### Modified Example 4

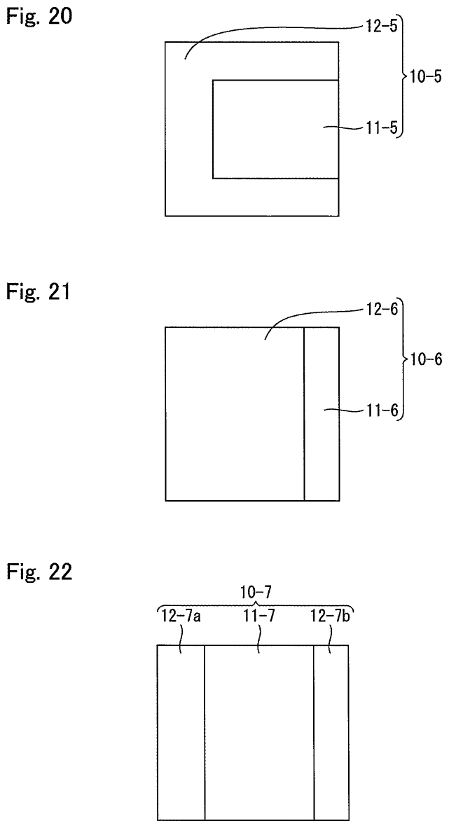

FIG. 20 is a schematic plan view of a light-transmissive member 10-5 used for a light-emitting device of Modified Example 4.

In the light-emitting device of Modified Example 4, the constitution other than the light-transmissive member 10-5 is the same as in the light-emitting device of the first embodiment.

As shown in FIG. 20, in the light-transmissive member 10-5 of the light-emitting device of Modified Example 4, a second light-transmissive portion 12-5 lies along three sides of a rectangular shape in a plan view, and a first light-transmissive portion 11-5 is surrounded by the second light-transmissive portion 12-5.

The second light-transmissive portion 12-5 lies along three sides of the rectangular shape in a plan view in the light-transmissive member 10-5 of the light-emitting device of Modified Example 4, but the first light-transmissive portion 11-5 may lie along three sides to surround the second light-transmissive portion 12-5. In the light-emitting device of Modified Example 4 constituted as described above, the high-luminance region and the low-luminance region can be arranged in various shapes in the emission surface by using constitutions having various shapes corresponding to the respective planar shapes of the second light-transmissive portion 12-5 and the first light-transmissive portion 11-5 in the light-transmissive member 10-5.

### Modified Example 5

FIG. 21 is a schematic plan view of a light-transmissive member 10-6 used for a light-emitting device of Modified Example 5.

In the light-emitting device of Modified Example 5, the constitution other than the light-transmissive member 10-6 is the same as in the light-emitting device of the first embodiment.

As shown in FIG. 21, in the light-transmissive member 10-6 of the light-emitting device of Modified Example 5, a second light-transmissive portion 12-6 has an area greater than the area of the first light-transmissive portion 11-6 in a plan view.

In FIG. 21, the second light-transmissive portion 12-6 has an area greater than the area of the first light-transmissive portion 11-6 in a plan view, but the first light-transmissive portion 11-6 may have an area greater than the area of the second light-transmissive portion 12-6 in a plan view.

In the light-emitting device of Modified Example 5 constituted as described above, the area ratio between the first light-emitting region and the second light-emitting region can be a desired area ratio.

### Modified Example 6

FIG. 22 is a schematic plan view of a light-transmissive member 10-7 used for a light-emitting device of Modified Example 6.

In the light-emitting device of Modified Example 6, the constitution other than the light-transmissive member 10-7 is the same as in the light-emitting device of the first embodiment.

As shown in FIG. 22, in the light-transmissive member 10-7 of the light-emitting device of Modified Example 6, two second light-transmissive portions are located on both sides of a first light-transmissive portion 11-7, and one second light-transmissive portion 12-7a has an area greater than the area of the other second light-transmissive portion 12-7b. The areas of the second light-emitting regions corresponding to the one second light-transmissive portion 12-7a and the other second light-transmissive portion 12-7b can be different from each other.

In the light-emitting device of Modified Example 6 constituted as described above, the areas of the first light-emitting region and the second light-emitting regions on both sides may have a desired area ratio.

### Modified Example 7

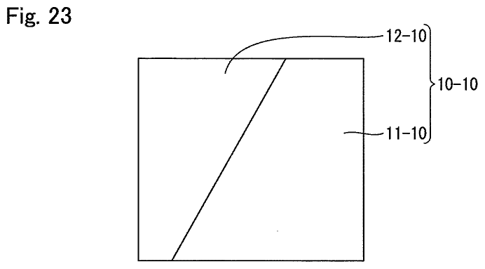

FIG. 23 is a schematic plan view of a light-transmissive member 10-10 used for a light-emitting device of Modified Example 7.

In the light-emitting device of Modified Example 7, the constitution other than the light-transmissive member 10-10 is the same as in the light-emitting device of the first embodiment.

As shown in FIG. 23, in the light-transmissive member 10-10 of the light-emitting device of Modified Example 7, a first light-transmissive portion 11-10 and a second light-transmissive portion 12-10 have different areas. The planar shapes of the first light-transmissive portion 11-10 and the second light-transmissive portion 12-10 are trapezoids. Specifically, the light-transmissive member 10-10 of Modified Example 7 is rectangular in a plan view, one trapezoidal portion formed by division by a straight line connecting points on the respective opposite sides of the rectangular light-transmissive member 10-10 is the first light-transmissive portion 11-10, and the other trapezoidal portion formed by the division is the second light-transmissive portion 12-10.

In the light-emitting device of Modified Example 7 constituted as described above, the first light-emitting region and the second light-emitting region can have trapezoidal shapes respectively corresponding to the planar shape of the first light-transmissive portion 11-10 and the planar shape of the second light-transmissive portion 12-10.

### Second Embodiment

A light-emitting device 200 of a second embodiment according to the present disclosure differs from the light-emitting device 100 of the first embodiment in that a light-emitting element 2 includes a first light-emitting portion 21 and a second light-emitting portion 22, light emitted from the first light-emitting portion 21 enters the first light-transmissive portion 11 of the light-transmissive member 10, and light emitted from the second light-emitting portion 22 enters the second light-transmissive portion 12 of the light-transmissive member 10. The wiring structure of the wiring board is also different because the light-emitting element 2 includes the first light-emitting portion 21 and the second light-emitting portion 22.

Features of the light-emitting device 200 of the second embodiment different from the light-emitting device 100 of the first embodiment are mainly described below.

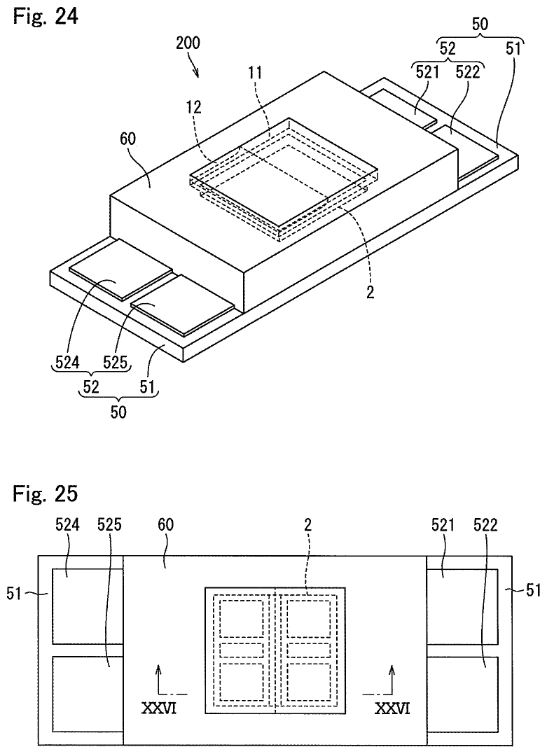

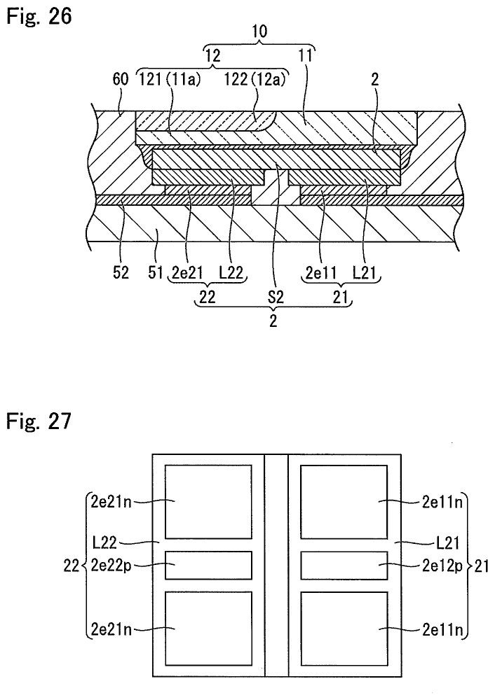

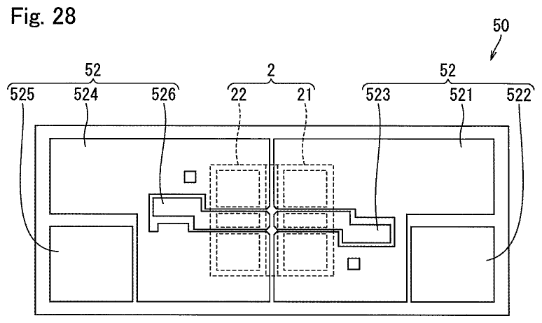

FIG. 24 is a schematic perspective view of the light-emitting device 200 according to the second embodiment. FIG. 25 is a schematic plan view taken from above the light-emitting device 200 according to the second embodiment. FIG. 26 is a schematic cross-sectional view taken along the line XXVI-XXVI of FIG. 25. FIG. 27 is a schematic plan view showing the electrode arrangement of the light-emitting element 2, and FIG. 28 is a schematic plan view of the wiring of the wiring board 50.

The light-emitting element 2 in the light-emitting device 200 according to the second embodiment includes the first light-emitting portion 21 and the second light-emitting portion 22 on a supporting substrate S2. The first light-emitting portion 21 includes a first semiconductor structure body L21 disposed on the supporting substrate S2 and element electrodes 2e11 disposed on the first semiconductor structure body L21. The second light-emitting portion 22 includes a second semiconductor structure body L22 disposed on the supporting substrate S2 and element electrodes 2e21 disposed on the second semiconductor structure body L22. For example, the first semiconductor structure body L21 and the second semiconductor structure body L22 are separated from each other on the supporting substrate S2.

For example, the first light-emitting portion and the second light-emitting portion, in other words, the first semiconductor structure body L21 and the second semiconductor structure body L22, may have the same semiconductor structure or different semiconductor structures. The element electrodes are respectively provided for the first semiconductor structure body L21 and the second semiconductor structure body L22, which allows for independent illumination. Connecting the respective element electrodes of the first light-emitting portion and the second light-emitting portion in series allows for collective illumination. In the case in which the first semiconductor structure body L21 and the second semiconductor structure body L22 emit light of the same emission color, the first light-emitting region R1 and the second light-emitting region R2 can emit light of different emission colors by adjusting the contents of phosphor particles, light-reflective particles, and the like in the first light-transmissive portion 11 and the second light-transmissive portion 12 in the light-transmissive member 10.

In the light-emitting device 200 according to the second embodiment, for example, as shown in FIG. 27, the electrodes of the light-emitting element 2 can be such that, on the first semiconductor structure body L21 and the second semiconductor structure body L22, respectively, p-electrodes 2e12p and 2e22p are provided on central portions and n-electrodes 2e11n and 2e21n are provided on both sides of the p-electrodes 2e12p and 2e22p. FIG. 27 shows an example in which the first semiconductor structure body L21 and the second semiconductor structure body L22 are separated from each other, but the p-side semiconductor layers or the n-side semiconductor layers may be connected to each other while the active layers of the first semiconductor structure body L21 and the second semiconductor structure body L22 are separated from each other.

In the light-emitting device 200 according to the second embodiment, for example, as shown in FIG. 28, wiring 52 in the wiring board 50 includes first wiring 521, second wiring 522, and third wiring 523 connected to the first light-emitting portion 21 and fourth wiring 524, fifth wiring 525, and sixth wiring 526 connected to the second light-emitting portion 22.

The third wiring 523 is located at a position facing the p-electrode 2e12p in the region in which the first light-emitting portion 21 is mounted. The first wiring 521 is provided to include positions facing the n-electrodes 2e11n of the first light-emitting portion 21, that is, internal connection portions located on both sides of the third wiring 523 and a first external connection portion extending from the mounting portion to an end portion. The second wiring 522 is located side by side with the first external connection portion on the one end portion of the wiring board. For example, the second wiring 522 and the third wiring 523 are connected to each other with an electroconductive member such as a wire or relay wiring or the like in the base so as not to be electrically connected to the first wiring 521.

The fourth wiring 524, the fifth wiring 525, and the sixth wiring 526 are also provided in the same manner as for the first wiring 521, the second wiring 522, and the third wiring 523 in the region in which the second light-emitting portion 22 is mounted.

An example in which the first wiring 521 and the fourth wiring 524, and the third wiring 523 and the sixth wiring 526 are both electrically separated on the base has been described above, but the pair of the first wiring 521 and the fourth wiring 524 or the pair of the third wiring 523 and the sixth wiring 526 may be electrically connected to each other.

On the wiring board 50 constituted as described above, the light-emitting element 2 is mounted such that the p-electrode 2e12p of the first semiconductor structure body L21 is connected to the third wiring 523, the n-electrodes 2e11n are connected to the first wiring 521, the p-electrode 2e22p of the second semiconductor structure body L22 is connected to the sixth wiring 526, and the n-electrodes 2e21n are connected to the fourth wiring 524.

In the light-emitting device 200 of the second embodiment, the light-transmissive member 10 is constituted in the same manner as in the light-emitting device 100 of the first embodiment and is disposed such that the first light-transmissive portion 11 is located above the first light-emitting portion 21 across the supporting substrate S2, and the second light-transmissive portion 12 is located above the second light-emitting portion 22 across the supporting substrate S2.

In the light-emitting device 200 of the second embodiment constituted as described above, the light-transmissive member 10 includes the first light-transmissive portion 11 containing phosphor particles and the second light-transmissive portion 12 containing light-reflective particles, so that the first light-emitting region R1 and the second light-emitting region R2 can emit light having different luminances.

In the light-emitting device 200 of the second embodiment, the light-transmissive member 10 includes the first light-transmissive portion 11 containing phosphor particles and the second light-transmissive portion 12 containing light-reflective particles, so that the first light-emitting region R1 and the second light-emitting region R2 can emit light of the same emission color or different emission colors in the same manner as in the light-emitting device 100 of the first embodiment.

In particular, in the light-emitting device 200 of the second embodiment, the emission colors and emission intensities of the first light-emitting portion 21 and the second light-emitting portion 22 can be selected as desired, so that the difference in luminance and difference in emission color between the first light-emitting region R1 and the second light-emitting region R2 can be easily increased.

The first light-emitting portion 21 and the second light-emitting portion 22 can be independently illuminated, so that the luminance of the first light-emitting region R1 or the second light-emitting region R2 can be substantially zero.

The emission color and emission intensity of the first light-emitting portion 21 and the emission color and emission intensity of the second light-emitting portion 22 can be available in various selections, so that a light-emitting device including the first light-emitting region R1 and the second light-emitting region R2 having desired emission colors and emission intensities can be provided.

The light-emitting devices according to the embodiments in the present disclosure can be preferably used for lightings for vehicles such as headlights. In addition, the light-emitting devices according to the embodiments of the present disclosure can be used for backlight sources for liquid-crystal displays, various lighting apparatuses, large screen displays, and various display devices such as advertisements and information boards, as well as image scanners, projector devices, and the like in digital video cameras, facsimile machines, copying machines, scanners, and the like.

1. A light-emitting device comprising:
a light-emitting element; and
a plate-shaped light-transmissive member disposed on or above the light-emitting element, the light-transmissive member having a lower surface configured to receive light emitted from the light-emitting element and an upper surface opposite to the lower surface, the upper surface of the light-transmissive member serving as an emission surface, the light-transmissive member including
a first light-transmissive portion including a first sintered body containing a phosphor particle, and
a second light-transmissive portion including a second sintered body containing a light-diffusing particle, the second sintered body having a relative density of 70% or more and 95% or less,
wherein the emission surface includes
a first light-emitting region configured to emit light through the first light-transmissive portion, and
a second light-emitting region configured to emit light through the second light-transmissive portion at a lower luminance than in the first light-emitting region.

2. The light-emitting device according to claim 1, wherein
the second light-transmissive portion includes a first layer and a second layer,
the second layer is constituted of the second sintered body, and
the second layer has a light transmittance lower than a light transmittance of the first layer.

3. The light-emitting device according to claim 2, wherein
the first layer and the first light-transmissive portion are integrally formed, and
the first layer and the first light-transmissive portion are constituted of the first sintered body.

4. The light-emitting device according to claim 2, wherein
the first layer constitutes a portion of the lower surface of the light-transmissive member, and
the second layer constitutes a portion of the emission surface of the light-transmissive member.

5. The light-emitting device according to claim 3, wherein
the first layer constitutes a portion of one of the lower surface of the light-transmissive member and the emission surface of the light-transmissive member,
the second layer constitutes a portion of the other of the lower surface of the light-transmissive member and the emission surface of the light-transmissive member, and
a lateral surface of the second layer is inclined with respect to the emission surface.

6. The light-emitting device according to claim 1, wherein
the second sintered body includes a base member containing an inorganic material and the light-diffusing particle containing an inorganic material in the base member.

7. The light-emitting device according to claim 6, wherein
the base member is mainly consisting of aluminum oxide.

8. The light-emitting device according to claim 7, wherein
the light-diffusing particle contains yttrium oxide or boron nitride.

9. The light-emitting device according to claim 1, further comprising
a covering member covering a lateral surface of the light-emitting element and a lateral surface of the light-transmissive member.

10. The light-emitting device according to claim 1, further comprising
an anti-reflection film covering the emission surface.

11. The light-emitting device according to claim 1, wherein
the light-emitting element includes
a supporting substrate, and
a first light-emitting portion and a second light-emitting portion on the supporting substrate, and
a boundary between the first light-transmissive portion and the second light-transmissive portion on the upper surface of the light-transmissive member is located between the first light-emitting portion and the second light-emitting portion.

12. A method of manufacturing a light-emitting device, comprising:
providing a light-emitting element having an upper surface serving as a light exit surface;
providing a light-transmissive member including
a first light-transmissive portion having a first light incident surface and a first light exit surface and
a second light-transmissive portion having a second light incident surface and a second light exit surface, and having a transmittance of light lower than in the first light-transmissive portion; and
disposing the light-transmissive member on or above the light-emitting element so that the first light incident surface and the second light incident surface face the light exit surface of the light-emitting element.

13. The method of manufacturing a light-emitting device according to claim 12, wherein
the providing of the light-transmissive member includes
providing a light-transmissive substrate containing an inorganic material and having a first main surface and a second main surface opposite to the first main surface,
forming a recess in the first main surface,
forming in the recess a sintered portion having a lower light transmittance than a light transmittance of the light-transmissive substrate by disposing in the recess a powder containing (i) a base member made of an inorganic material and (ii) a light-diffusing particle made of an inorganic material, and sintering the powder, and
dividing the light-transmissive substrate including the sintered portion to form the light-transmissive member including the first light-transmissive portion made of a portion of the light-transmissive substrate and the second light-transmissive portion including a portion of the sintered portion and a portion of the light-transmissive member.

14. The method of manufacturing a light-emitting device according to claim 13, wherein
the forming of the sintered portion includes forming the sintered portion so that a relative density of the sintered portion to 70% or more and 95% or less.

15. The method of manufacturing a light-emitting device according to claim 13, wherein
the sintering of the powder includes applying a current while pressure is applied to the powder.

16. The method of manufacturing a light-emitting device according to claim 15, wherein
the forming of the recess includes forming the recess that has a lateral surface inclined from a bottom of the recess toward the first main surface.

17. The method of manufacturing a light-emitting device according to claim 16, wherein
the forming of the recess includes forming the recess to have an edge defining a straight line in the first main surface.

18. The method of manufacturing a light-emitting device according to claim 13, wherein
the base member is mainly consisting of aluminum oxide.

19. The method of manufacturing a light-emitting device according to claim 18, wherein
the light-diffusing particle contains an yttrium oxide or boron nitride particle.
